(19) United States
(12) Patent Application Publication
(10) Pub. No.: US 2022/0152847 A1
(43) Pub. Date: May 19, 2022

(54) ROBOT HAND

(71) Applicant: Panasonic Intellectual Property Management Co., Ltd., Osaka (JP)

(72) Inventors: Yuzuka ISOBE, Osaka (JP); Yoshinari MATSUYAMA, Osaka (JP); Tomoyuki YASHIRO, Osaka (JP); Kozo EZAWA, Osaka (JP)

(21) Appl. No.: 17/592,949

(22) Filed: Feb. 4, 2022

Related U.S. Application Data
(63) Continuation of application No. PCT/JP2020/029260, filed on Jul. 30, 2020.

(30) Foreign Application Priority Data
Aug. 15, 2019 (JP) 2019-149219

(51) Int. Cl. B25J 15/08; B25J 15/00

(52) U.S. Cl. CPC B25J 15/08; B25J 15/0033

(57) ABSTRACT

Provided is a robot hand including a movable unit, a hand that changes in shape in accordance with movement of the movable unit, and an elastic body that changes a gripping force of the hand. When the amount of movement of the movable unit is less than a predetermined value, at least the hand changes in shape, and when the amount of movement of the movable unit is more than or equal to the predetermined value, the elastic body changes in elastic force while at least a part of the hand stops changing in shape.

### BACKGROUND

### 1. Technical Field

The present disclosure relates to a robot hand.

### 2. Description of the Related Art

Patent Literature (PTL) 1 discloses a robot hand including at least one robot finger disposed on a base, the at least one robot finger including a plurality of links, a plurality of joint shafts rotatably connected between the links, a plurality of actuators for driving the joint shafts, a plurality of cables for transmitting currents and signals to the actuators, wherein at least one pair of the joint shafts adjacent to each other includes a first joint shaft that is connected to one end of an elastic body, and a second joint shaft that rotates relative to the first joint shaft and is attached to the other end of the elastic body, and the corresponding cables move along the elastic body.

PTL 1 is Unexamined Japanese Patent Publication No. 2008-178968.

### SUMMARY

The present disclosure has been devised in view of the above-mentioned conventional situation, and an object of the present disclosure is to provide a robot hand capable of gripping each of workpieces in various shapes by adjusting a gripping force.

The present disclosure provides a robot hand including a movable unit, a hand that changes in shape in accordance with movement of the movable unit, and an elastic body that changes a gripping force of the hand. When an amount of movement of the movable unit is less than a predetermined value, at least the hand changes in shape, and when the amount of movement of the movable unit is more than or equal to the predetermined value, the elastic body changes in elastic force while at least a part of the hand stops changing in shape.

The present disclosure enables providing a robot hand capable of gripping each of workpieces in various shapes by adjusting a gripping force.

### BRIEF DESCRIPTION OF DRAWINGS

FIG. 1 is a diagram illustrating a configuration example of robot arm 1 and end effector 2 (robot hand).

FIG. 2 is a plan view illustrating an example of end effector 2 (robot hand) of the present disclosure.

FIG. 3 is a side view corresponding to FIG. 2.

FIG. 4 is a perspective view of end effector 2 (robot hand) of the present disclosure.

FIG. 5 is a block diagram illustrating an example of a hardware configuration of control system 100.

FIG. 6 is a plan view of end effector 2 (robot hand) of the present disclosure in an initial state.

FIG. 7 is a plan view illustrating end effector 2 in a gripping transition operation state following FIG. 6.

FIG. 8 is a plan view illustrating end effector 2 in a gripped state following FIG. 7.

FIG. 9 is a plan view illustrating end effector 2 in a gripping force control state following FIG. 8.

FIG. 10 is a plan view illustrating end effector 2 (robot hand) of the present disclosure in a modification of a gripped state.

FIG. 11 is a schematic view illustrating gripper G of the present disclosure in gripped states including part (a) general gripping, part (b) slightly tilted gripping, and part (c) gripping in the same modification as in FIG. 10.

FIG. 12 illustrates end effector 2 (robot hand) according to an exemplary embodiment of the present disclosure to grip a large work, and includes part (a) that is a plan view of end effector 2 (robot hand) in an initial state, and part (b) that is a plan view thereof in a gripped state.

FIG. 13 illustrates end effector 2 (robot hand) according to an exemplary embodiment of the present disclosure to grip large workpiece W, and includes part (a) that is a plan view in a state where gripping-force-control is completed following FIG. 12, and part (b) that is a graph showing transition of lengths of arrows A to C illustrated in FIG. 12 and in part (a) of FIG. 13.

FIG. 14 illustrates end effector 2 (robot hand) according to an exemplary embodiment of the present disclosure to grip small workpiece W, and includes part (a) that is a plan view in a state where gripping-force-control is completed, and part (b) that is a graph showing transition of lengths of arrows A to C illustrated in part (a) of FIG. 14.

### DETAILED DESCRIPTION

### Background to the Present Disclosure

A robot apparatus used in a factory or the like is capable of performing various operations by attaching an end effector to a robot arm. Example of the operations include an operation of picking a workpiece (work object) flowing on a production line of a factory by using a robot hand as an end effector.

As disclosed in PTL 1, there is a robot hand provided with an actuator for each joint shaft of a finger. Providing the actuator for each joint shaft of the finger enables each joint to be appropriately controlled by the actuator. Unfortunately, the configuration in which the actuator is provided for each joint shaft of the finger increases the number of actuators. The actuators are each expensive and heavy. In particular, when the actuator is provided at a leading end of the robot hand, a burden of a weight of the actuator increases, and wiring for moving the actuator also becomes cumbersome.

Thus, the present disclosure provides a robot hand capable of gripping each of workpieces having various shapes while reducing the number of actuators used for the robot hand.

Reducing the number of actuators causes a difficulty in adjusting a gripping force to grip a workpiece with the robot hand.

Thus, the present disclosure provides a robot hand capable of adjusting a gripping force while reducing the number of actuators used for the robot hand.

Hereinafter, an exemplary embodiment (hereinafter referred to as “the present exemplary embodiment”) in which the robot hand according to the present disclosure is specifically disclosed will be described in detail with reference to the drawings as appropriate. However, an unnecessarily detailed description may be eliminated. For example, the detailed description of already well-known matters and the redundant description of a configuration substantially identical to the already-described configuration may be eliminated. This is to avoid the following description from being unnecessarily redundant and thus to help those skilled in the art to easily understand the description.

The attached drawings and the following description are provided for those skilled in the art to fully understand the present disclosure, and are not intended to limit the subject matter described in the scope of claims.

In the present exemplary embodiment below, an end effector assumed as a robot hand having two fingers will be described. The end effector can have various shapes. For example, the end effector can grip a workpiece being a work object with two (or five, etc.) fingers, suck and support the workpiece using a suction part, or hook the workpiece by inserting a bent finger into a hook provided on the workpiece. In any case, the end effector grips the workpiece to perform some work.

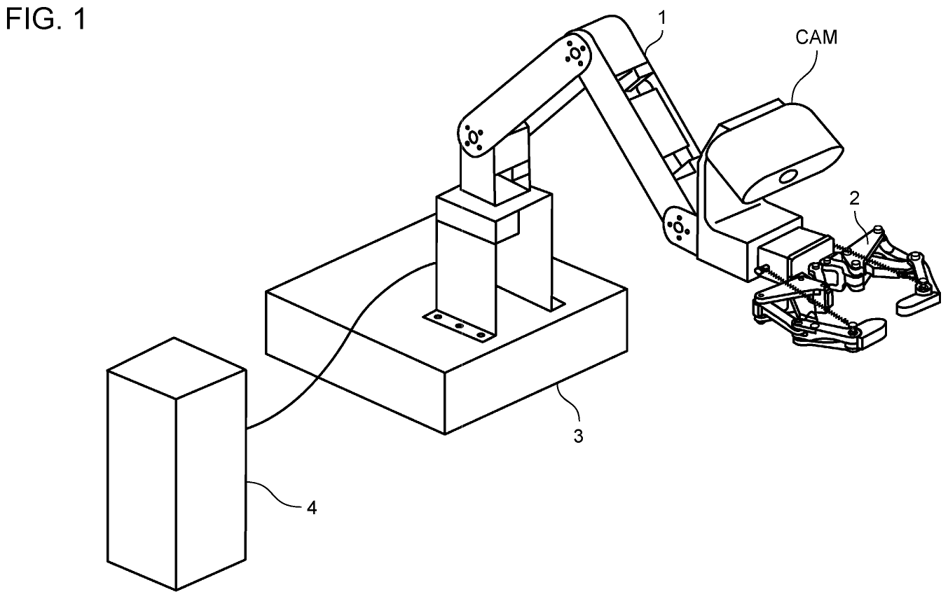

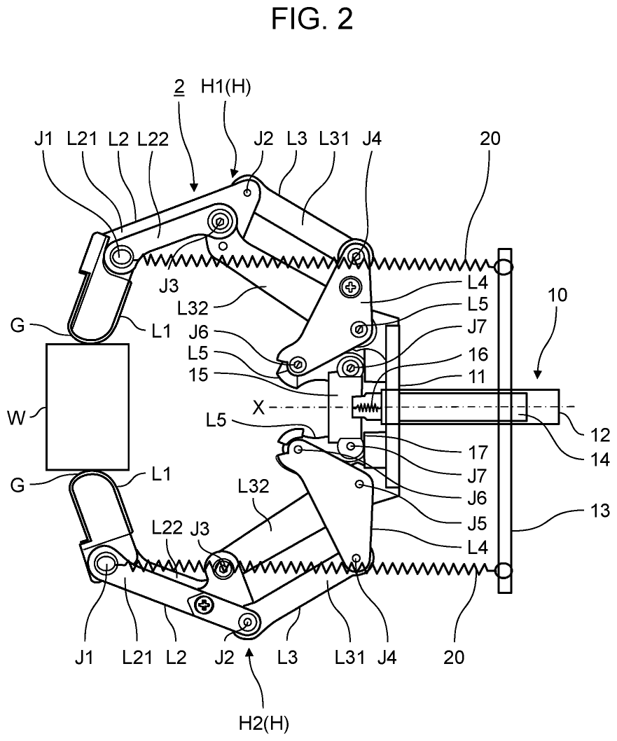

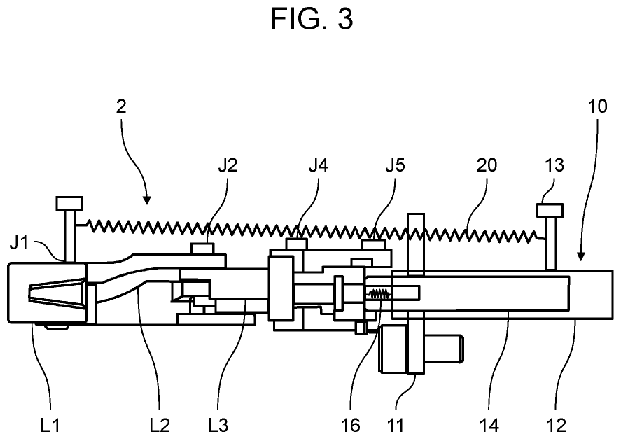

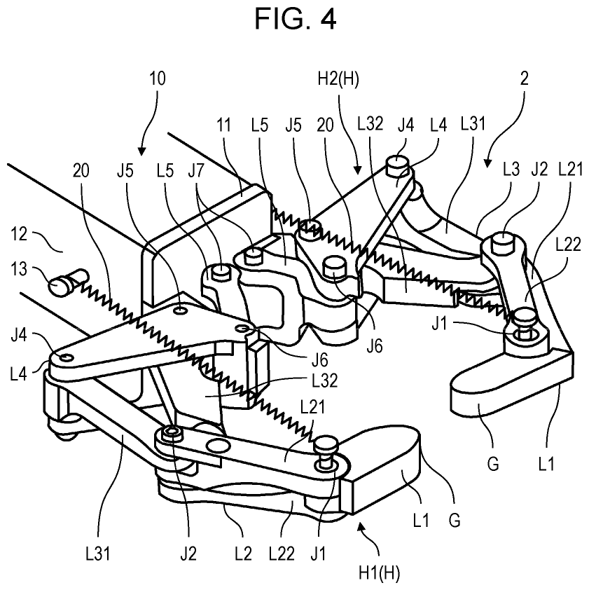

FIG. 1 is a diagram illustrating a configuration example of robot arm 1 and end effector 2 (robot hand). FIG. 2 is a plan view illustrating an example of end effector 2 (robot hand) of the present disclosure. FIG. 3 is a side view corresponding to FIG. 2. FIG. 4 is a perspective view of end effector 2 (robot hand) of the present disclosure. With reference to FIGS. 1 to 4, end effector 2 (robot hand) of the present disclosure will be described in detail.

As illustrated in FIG. 1, end effector 2, which may be the robot hand of the present disclosure, is used by being connected to robot arm 1. Control system 100 described later controls a robot apparatus including robot arm 1 and end effector 2. This example includes controller 4 in the shape of a box that is connected to end effector 2 through robot arm 1 disposed on base 3.

As illustrated in FIG. 1, end effector 2 may be provided with camera CAM. Control system 100 described later may control end effector 2 based on an image captured by camera CAM. Camera CAM may be disposed at a position where images of end effector 2 and workpiece W being a work object of end effector 2 can be captured. That is, the images captured by camera CAM simultaneously reflect the shape of end effector 2 and the shape of workpiece W being a work object for being supported (grasped). Although camera CAM is disposed near a connection portion between end effector 2 and robot arm 1, camera CAM may be disposed in a place other than this.

End effector 2, which may be the robot hand of the present disclosure, includes hand H, movable unit 10, and spring 20 (see FIGS. 2 to 4). This example includes hand H that is composed of two hands of first hand H1 and second hand H2. However, the number of hands H is not limited to two. Hand H changes in shape in accordance with movement of movable unit 10, and spring 20 changes a gripping force of hand H.

As illustrated in FIGS. 2 and 4, first hand H1 includes five links L in this example. That is, five links L include first link L1, second link L2, third link L3, fourth link L4, and fifth link L5 in order from a leading end of first hand H1. Second link L2 includes twenty-first link L21 and twenty-second link L22 that are paired. Twenty-first link L21 and twenty-second link L22 are disposed facing each other in a thickness direction of end effector 2, and twenty-first link L21 is formed longer than twenty-second link L22. Third link L3 includes thirty-first link L31 and thirty-second link L32 that are paired. Thirty-first link L31 and thirty-second link L32 are disposed apart from each other and in a parallel manner.

Although the link outside hand H is referred as thirty-first link L31, and the link inside hand H is referred as thirty-second link L32, thirty-first and thirty-second, as well as first, second, and the like, are used for easy understanding of description, and thus do not particularly limit a positional relationship.

First link L1 has a leading end serving as gripper G for gripping workpiece W, and the other end joined to one end of second link L2. The joining is made using first joint shaft J1. Similarly, each link L is provided with joint shaft J, and each link L is rotatably joined to joint shaft J.

The second link L2 is provided at the other end with second joint shaft J2 to which one ends of twenty-first link L21 and thirty-first link L31 are joined, and with third joint shaft J3 to which twenty-second link L22 and thirty-second link L32 are joined. Thirty-first link L31 and thirty-second link L32, which are each the third joint from the leading end of the finger, have a structure in which rotational degrees of freedom remains, so that hand H can grip workpiece W different in shape and size even under identical control.

Fourth link L4 generally has the shape of a triangle while other links L each generally have the shape of a rectangle, and is provided near each apex of the triangle with joint shaft J. Three joint shafts J include fourth joint shaft J4 connected to the other end of thirty-first link L31, fifth joint shaft J5 connected to the other end of thirty-second link L32, and sixth joint shaft J6 connected to one end of fifth link L5. The other end of fifth link L5 is connected to seventh joint shaft J7 provided at each of opposite ends of retainer 15 described later. Second hand H2 also has the same configuration as first hand H1 in the present exemplary embodiment, and thus duplicated description thereof is eliminated.

First hand H1 and second hand H2 each have gripper G at the leading end of first link L1. FIG. 2 illustrates workpiece W being a work object, for example. Although workpiece W has a rectangular parallelepiped shape in the example of FIG. 2, workpiece W is actually different in size, shape, hardness, or weight. Two grippers G provided on first hand H1 and second hand H2 sandwich workpiece W to grip workpiece W.

Movable unit 10 is movably attached to base 11 fixed to robot arm 1, and hand H changes in shape with movement of movable unit 10. Movable unit 10 is driven by an actuator controlled using, for example, a motor or a gear, and the actuator is, for example, an electric type, a hydraulic type, a pneumatic type, or the like. In a positional relationship in which gripper G for gripping workpiece W is provided at the leading end of hand H, and movable unit 10 that transforms hand H is connected to an end of hand H opposite to the leading end, the actuator is also disposed at the end of hand H opposite to the leading end.

Movable unit 10 has moving axis X, and includes base 11, move part 12 that moves along moving axis X, and support part 13 that is fixed to move part 12 and interlocks with movement of move part 12, support shaft 14 that stabilizes the movement of move part 12, and retainer 15 that is fixed to a leading end of support shaft 14. Move part 12 and retainer 15 are elastically pressed by elastic part 16. Springs 20 are fixed to respective opposite ends of support part 13 disposed orthogonally to moving axis X, and the other end of spring 20 is fixed to first joint shaft J1 connecting first link L1 and second link L2, and thus first hand H1 and second hand H2 are elastically pulled by movable unit 10. Base 11 is provided at its leading end with stopper 17. Move part 12 may be an actuator.

### Configuration of Control System

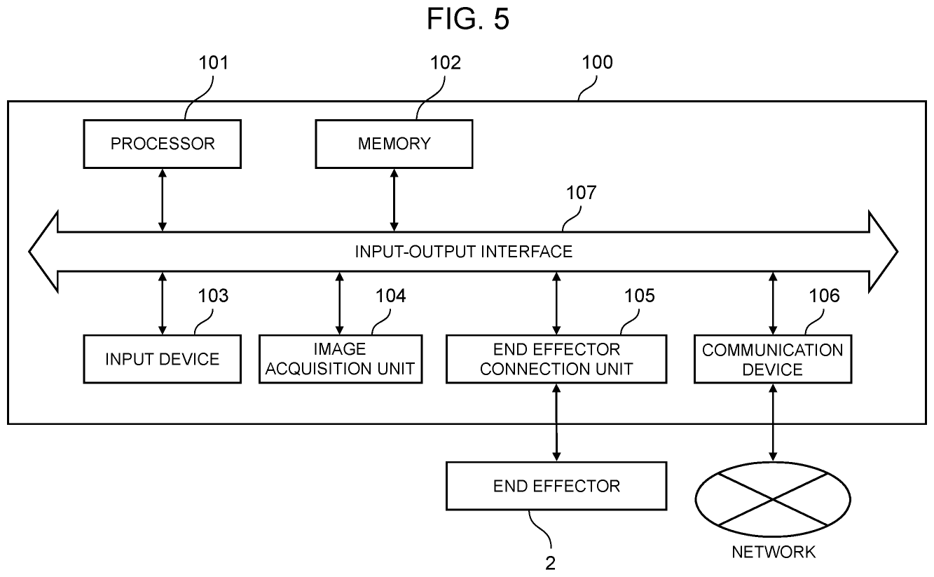

FIG. 5 is a block diagram illustrating an example of a hardware configuration of control system 100. Control system 100 controls operations of robot arm 1 and end effector 2.

Control system 100 in this example has a configuration including processor 101, memory 102, input device 103, image acquisition unit 104, end effector connection unit 105, communication device 106, and input-output interface 107. Memory 102, input device 103, image acquisition unit 104, end effector connection unit 105, communication device 106, and input-output interface 107 are each connected to processor 101 through an internal bus or the like to enable input and output of data or information to and from processor 101.

Processor 101 is composed of, for example, a central processing unit (CPU), a micro processing unit (MPU), a digital signal processor (DSP), or a field programmable gate array (FPGA). Processor 101 functions as a controller of control system 100, and performs a control process of comprehensively controlling operations of respective component units of control system 100, a process of input and output of data or information to and from respective component units of control system 100, a process of calculating data, and a process of storing data or information. Processor 101 also functions as a controller that controls end effector 2.

Memory 102 may include an HDD, a ROM, a RAM, and the like, and stores various programs (OS, application software, etc.) to be executed by processor 101, and various data.

Input device 103 may include a keyboard, a mouse, and the like, and has a function as a human interface with a user to receive operation of the user. In other words, input device 103 is used for input or instruction in various processes to be performed by control system 100. Input device 103 may be a programming pendant connected to controller 4.

Image acquisition unit 104 can be connected to camera CAM with a wire or wirelessly, and acquires an image captured by camera CAM. Control system 100 can appropriately perform image processing on an image acquired by image acquisition unit 104. Processor 101 may mainly perform this image processing. Control system 100 may further include an image processing unit (not illustrated), and the image processing unit may be connected to control system 100. Under control of processor 101, the image processing unit can perform image processing.

End effector connection unit 105 is a component that secures connection to end effector 2, which may be the robot hand of the present disclosure, and control system 100 and end effector 2 (and robot arm 1) are connected using end effector connection unit 105. This connection may be a wired connection using a connector, a cable, and the like, or may be a wireless connection. At the time of this connection, end effector connection unit 105 acquires identification information for identifying end effector 2 from end effector 2. That is, end effector connection unit 105 functions as an identification information acquisition unit. The identification information may be further acquired by processor 101 from end effector connection unit 105. The identification information enables identifying a type of end effector 2 connected.

Communication device 106 is a component for communicating with the outside via a network. This communication may be wired communication or wireless communication.

Input-output interface 107 has a function as an interface for inputting and outputting data or information to and from control system 100.

The above configuration of control system 100 is an example, and thus control system 100 may not necessarily include all the above components. Control system 100 may further include additional components. For example, control system 100 (controller 4) in the shape of a box may have wheels, and control system 100 may run by itself while robot arm 1 and end effector 2 are mounted thereon.

### Operation of Robot Hand

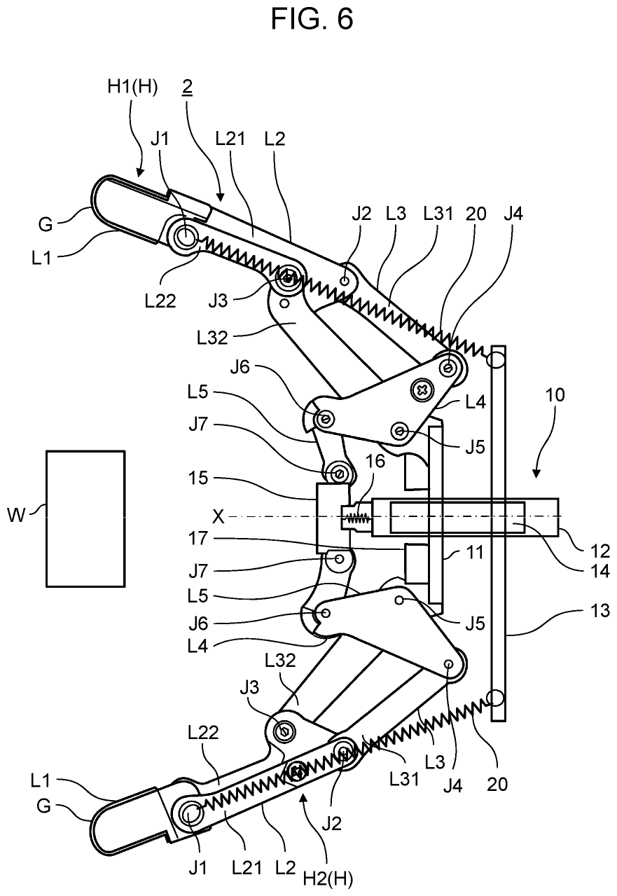

Next, operation of end effector 2, which may be the robot hand of the present disclosure, to grip workpiece W will be described with reference to FIGS. 6 to 9.

### Initial State: See FIG. 6

To perform work, end effector 2 is caused to approach workpiece W. While camera CAM captures an image, control system 100 controls changing in shape of end effector 2, suitable for workpiece W, based on the image acquired by image acquisition unit 104. This control may also include control of the actuator described above. At this point, retainer 15 is not in contact with stopper 17 of base 11, and is apart from stopper 17.

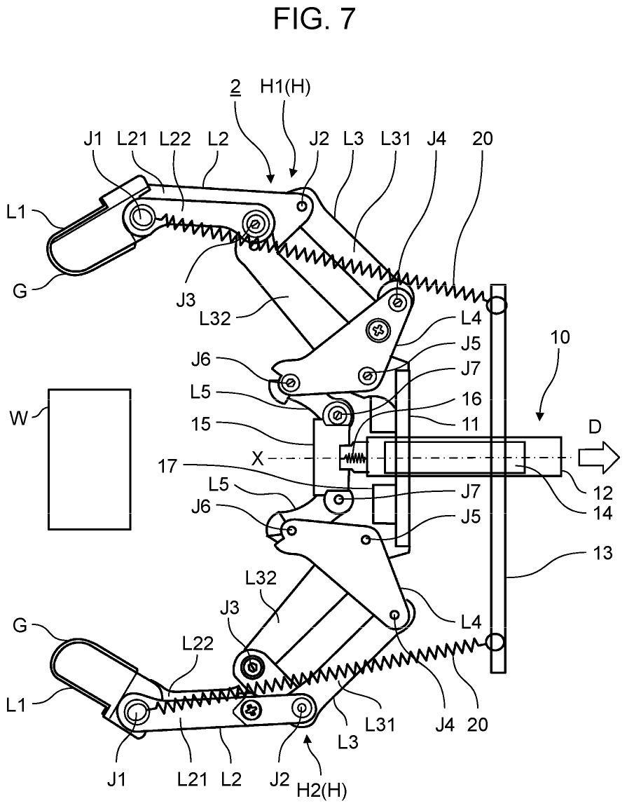

### Gripping Transition Operation State: See FIG. 7

Move part 12 of movable unit 10 is moved along moving axis X in a direction (D direction) away from workpiece W. This movement may be performed by an actuator. As move part 12 moves, support part 13 and retainer 15 move in the D direction. Following the movement of retainer 15, seventh joint shafts J7 provided at respective opposite ends of retainer 15 approach base 11, and sixth joint shafts J6 move to the inside of hand H. This movement causes rotation of fourth links L4 about respective fifth joint shafts J5. Then, fourth joint shafts J4 move inward of end effector 2, and second links L2 rotate about respective third joint shafts J3.

Although in an initial state (see FIG. 6), second links L2 are positioned forming an inverted V-shape that spreads forward with respect to moving axis X, second links L2 each turn and move to a position almost parallel to moving axis X (see FIG. 7). Second link L2 turns to cause first link L1 to rotate around first joint shaft J1. Then, gripper G of first link L1 faces toward workpiece W, and gripper G approaches workpiece W. Move part 12 in movable unit 10 is moved along moving axis X in a direction away from workpiece W (in the D direction), and thus increasing an elastic force of spring 20. Although retainer 15 then approaches stopper 17 of base 11, retainer 15 does not come into contact with stopper 17 in a state of FIG. 7.

When move part 12 is further moved in the D direction, fourth link L4 rotates further, and second link L2 also rotates further. Then, twenty-first link L21 presses more first link L1 and rotates more around first joint shaft J1, and thus causing gripper G of first link L1 to further approach workpiece W. Spring 20 always elastically pulls movable unit 10 and hand H, and can suppress a mechanical error due to turning of link L and absorb displacement due to vibration. In particular, spring 20 is connected to first joint shaft J1 and support part 13 of movable unit 10 in this example to stabilize movement of first link L1, so that workpiece W can be appropriately gripped even in work requiring accuracy of a gripping position.

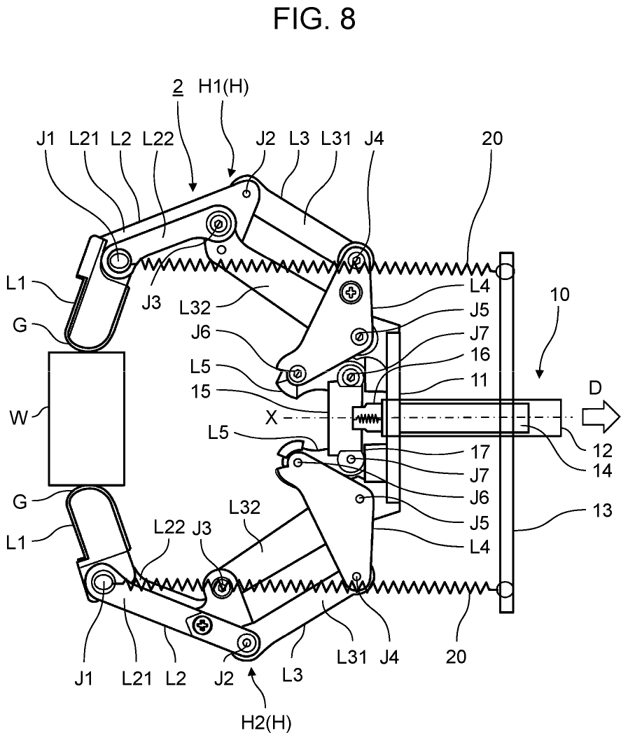

### Gripping State: See FIG. 8

As illustrated in FIG. 8, at timing when the amount of movement of move part 12 in the D direction increases to bring retainer 15 into contact with stopper 17 of the base 11, gripper G may grip workpiece W. Alternatively, gripper G may grip workpiece W before retainer 15 comes into contact with stopper 17 of base 11.

The amount of movement of movable unit 10 (move part 12 therein) from the initial state (see FIG. 6) to a state where retainer 15 is in contact with stopper 17 of base 11 is defined as a predetermined value of the amount of movement of movable unit 10. From the initial state (see FIG. 6) until the state where retainer 15 comes into contact with stopper 17 of base 11 (see FIG. 8), the amount of movement of movable unit 10 is less than the predetermined value, during which hand H continues to change in shape.

When retainer 15 comes into contact with stopper 17 of base 11 (when the amount of movement of movable unit 10 reaches the predetermined value), stopper 17 prevents further movement of retainer 15 in the D direction. This stops turning and the like of fourth link L4, caused by following movement of retainer 15. Thus, hand H stops changing in shape. However, first link L1 has a degree of freedom of inclination as described later, so that at least part of hand H stops changing in shape. That is, when the amount of movement of movable unit 10 reaches the predetermined value, stopper 17 stops changing in shape of at least part of hand H.

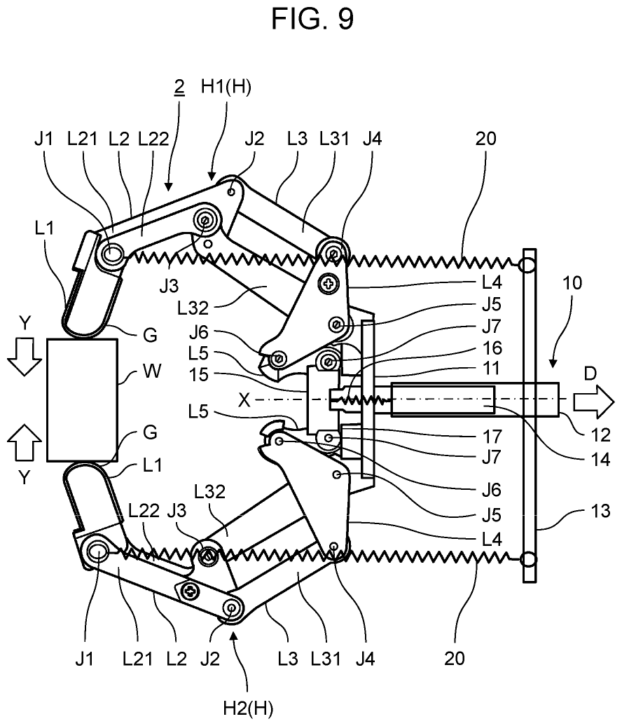

When the amount of movement of movable unit 10 is more than or equal to the predetermined value, i.e., when move part 12 of movable unit 10 further moves in the D direction, retainer 15 fails to move any further by being obstructed by stopper 17, and thus stopping changing in shape of hand H (at least part thereof). Then, spring 20 is further stretched. That is, spring 20 changes in elastic force. FIG. 9 illustrates change in gripping force due to change in elastic force.

### Gripping Force Control State: See FIG. 9

Move part 12 of movable unit 10 is further moved in the D direction. Then, the elastic force of spring 20 increases as move part 12 moves. When the elastic force of spring 20 increases, spring 20 pulls first joint shaft J1 more strongly. This causes gripper G to grip workpiece W by pressing workpiece W more strongly in a Y direction shown in FIG. 9. That is, as the elastic force of spring 20 increases, the gripping force of hand H increases.

As described above, when the amount of movement of movable unit 10 is less than the predetermined value, the changing in shape of hand H can be controlled by moving movable unit 10 (move part 12 in movable unit 10). In contrast, when the amount of movement of movable unit 10 is more than or equal to the predetermined value, the gripping force of gripper G can be controlled by moving movable unit 10 (move part 12 in movable unit 12).

Although the movement of movable unit 10 is described based on the present exemplary embodiment, hand H can be transformed by pulling movable unit 10 or twisting movable unit 10. That is, as long as hand H can be transformed in accordance with movement of movable unit 10, a configuration other than pulling movable unit 10 may be used. The amount of movement of movable unit 10 may be a value indicating the amount of movement. In a type of twisting movable unit 10, the value corresponds to the amount of movement in a twisting direction.

Adjusting the gripping force of gripper G by using an elastic force of an elastic body besides spring 20 described above does not require an actuator to be provided near the leading end of hand H, for example, on first joint shaft J1.

As a result, the number of actuators to be used can be reduced so that a robot hand low in cost and weight without requiring complicated wiring can be provided. When the robot hand of the present disclosure includes hand H provided with at least one actuator to move move part 12, the gripping force can be appropriately adjusted.

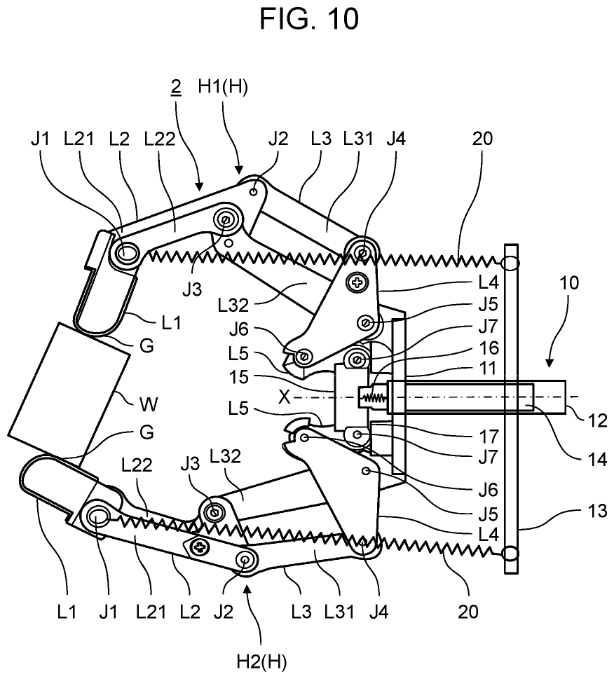

When gripper G grips workpiece W, a plurality of hands of first hand H1 and second hand H2 does not always grip workpiece W evenly. As illustrated in FIG. 10, although first link L1 of first hand H1 grips workpiece W with the leading end of gripper G, first link L1 of second hand H2 grips workpiece W with a side surface of gripper G. Even in such a case, workpiece W can be gripped with an appropriate gripping force by adjusting the elastic force of spring 20.

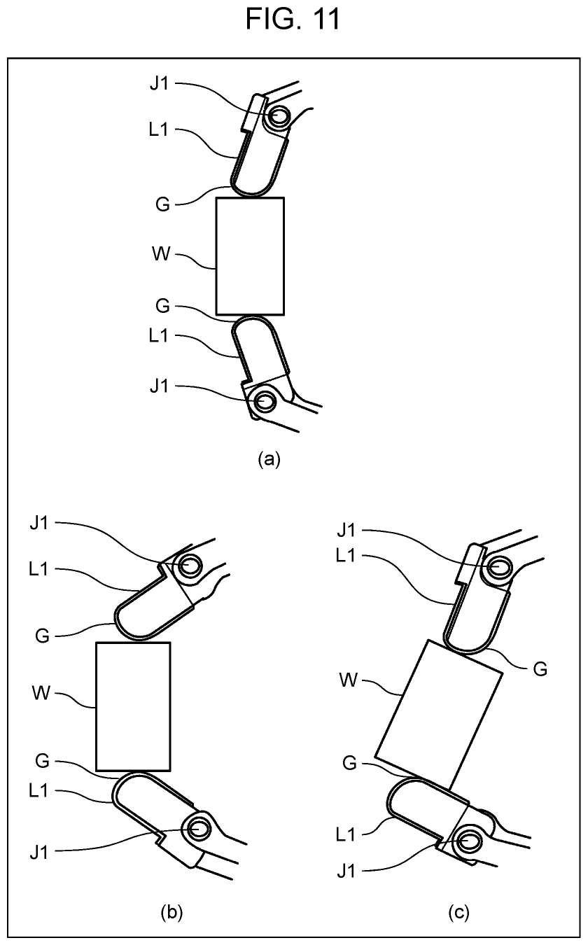

First link L1 has a degree of freedom in inclination, so that workpiece W is gripped in various states as illustrated in FIG. 11. The various states include a state where side surfaces of workpiece W are each gripped vertically as illustrated in part (a) of FIG. 11, a state where side surfaces of workpiece W are each gripped from a slightly oblique direction as illustrated in part (b) of FIG. 11, and a state where one side surface of workpiece W is gripped by the leading end of gripper G, and the other surface thereof is gripped by a side surface of gripper G as illustrated in part (c) of FIG. 11. Allowing first link L1 to have a degree of freedom of inclination as described above enables gripping workpiece

W different in shape, size, hardness, and the like with an appropriate gripping force.

### Adjustment of Gripping Force Based on Captured Image

As described above, hand H according to the present disclosure is capable of adjusting a gripping force of gripper G by using an elastic body such as spring 20. An elastic force of the elastic body may be adjusted based on an image captured by camera CAM and then acquired by image acquisition unit 104 of control system 100. Processor 101 acquires the above image using image acquisition unit 104 and derives an appropriate gripping force of gripper G based on shapes of end effector 2 and workpiece W reflected in the image to control end effector 2 (hand H) using end effector connection unit 105. This control also includes control of the actuator for moving move part 12. That is, control system 100 is capable of controlling a gripping force of gripper G based on an image captured by camera CAM.

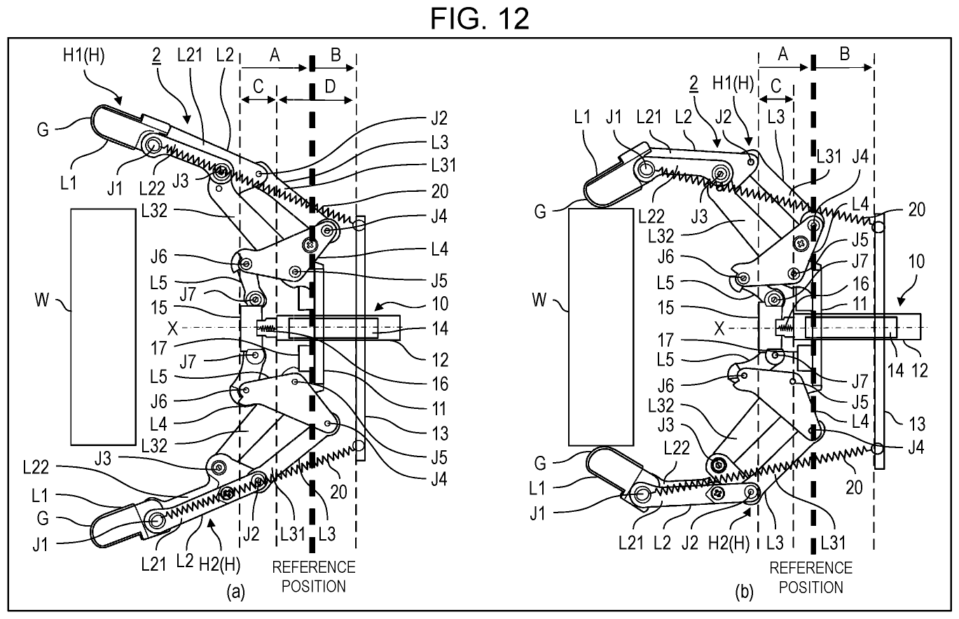

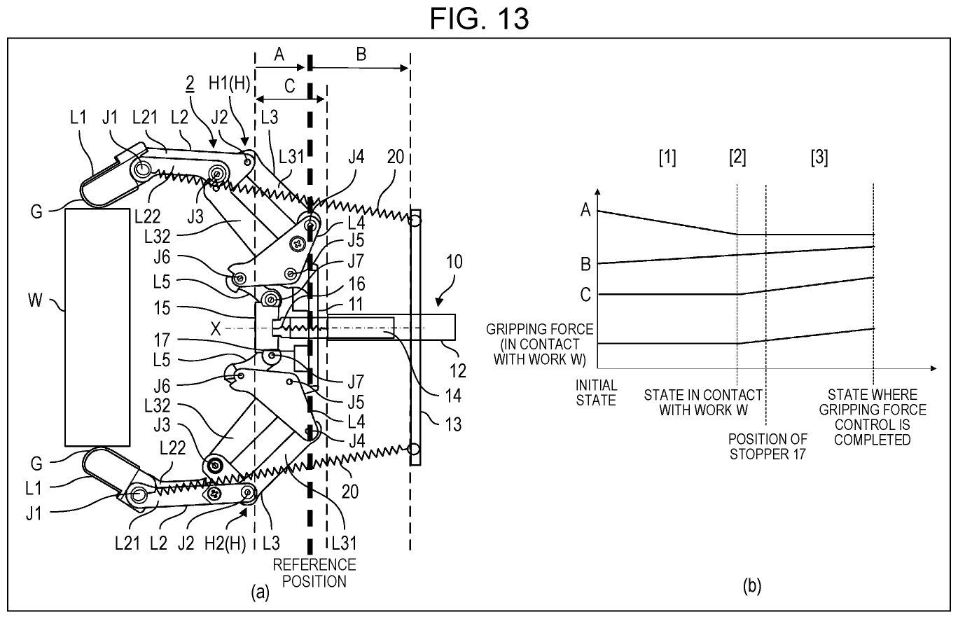

### Gripping of Large Workpiece: See FIGS. 12 and 13

FIGS. 12 and 13 each illustrate end effector 2 (robot hand) according to an exemplary embodiment of the present disclosure to grip a large workpiece. FIG. 12 includes part (a) illustrating an initial state, and part (b) illustrating a gripping state (a state where end effector 2 is in contact with workpiece W). FIG. 13 includes part (a) illustrating a state where gripping-force-control is completed. In the drawings, a bold broken line indicates a reference position, and arrow A indicates movement of retainer 15 interlocked with movement of the whole of hand H. Arrow B indicates movement of movable unit 10, and arrow C indicates movement of elastic part 16. Arrow D indicates a distance from a contact point between elastic part 16 and move part 12 to support part 13, and this distance is constant.

Before retainer 15 comes into contact with stopper 17 of base 11, gripper G grips workpiece W (part (b) of FIG. 12). FIG. 13 includes part (b) that is a graph showing movement of the whole of hand H (arrow A), movement of movable unit 10 (arrow B), and movement of elastic part 16 (arrow C) in a case of part (b) of FIG. 12. The graph of part (b) of FIG. 13 has a horizontal axis representing an elapsed time, and a vertical axis representing a distance (length of each arrow) from a start point to an end point of each of arrows A, B, and C.

During a period of time [1] in part (b) of FIG. 13, when movable unit 10 is driven in a direction of arrow B to increase arrow B in length, retainer 15 in conjunction with the whole of hand H moves in a direction of arrow A to shorten arrow A in length. Elastic part 16 is not stretched during this period of time, so that arrow C is still constant in length.

At time point [2] in part (b) of FIG. 13, when gripper G comes into contact with workpiece W to grip workpiece W, movement of retainer 15 in conjunction with movement of the whole of hand H stops at time point [2], and then retainer 15 does not come into contact with stopper 17. That is, arrow A is constant in length thereafter. In contrast, movable unit 10 is driven in the direction of arrow B to increase arrow B in length. Then, elastic part 16 begins to be stretched to increase arrow C in length. As also shown in the graph of part (b) of FIG. 13, a gripping force for workpiece W, generated by gripper G, also increases. This is because the elastic force of spring 20 increases as arrow B increases in length.

Even during a period of time [3] in part (b) of FIG. 13, the movement of retainer 15 in conjunction with movement of the whole of hand H still stops, and thus arrow A is constant in length. In contrast, movable unit 10 is driven in the direction of arrow B to further increase arrow B in length. Then, elastic part 16 is stretched to increase arrow C in length. As also shown in the graph of part (b) of FIG. 13, a gripping force for workpiece W, generated by gripper G, also increases.

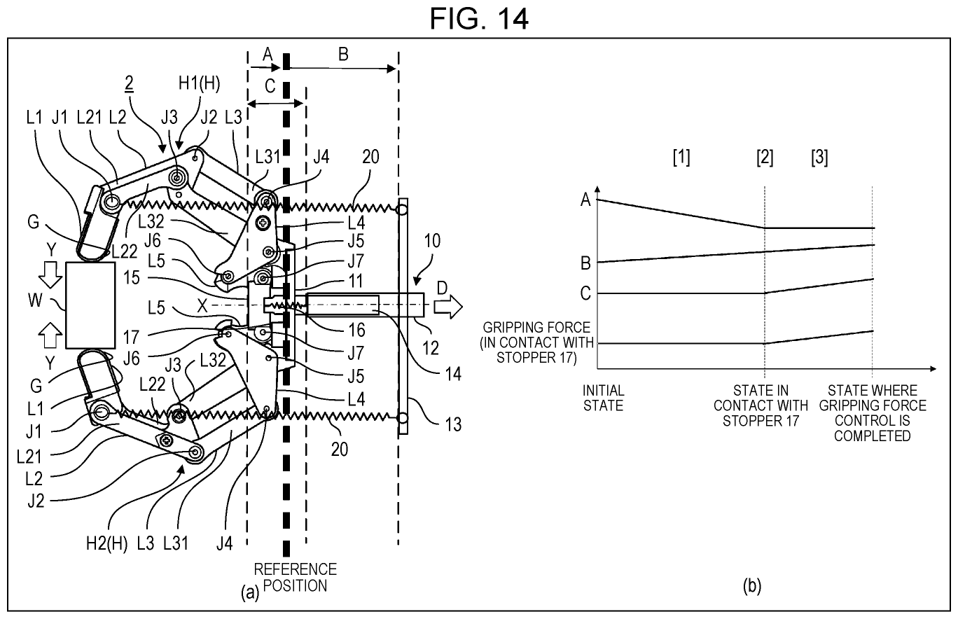

### Gripping of Small Workpiece: See FIG. 14

FIG. 14 illustrates end effector 2 (robot hand) according to an exemplary embodiment of the present disclosure to grip a small workpiece. FIG. 14 includes part (a) illustrating a state where gripping-force-control is completed.

In the drawings, a bold broken line indicates a reference position, and arrow A indicates movement of retainer 15 interlocked with movement of the whole of hand H. Arrow B indicates movement of movable unit 10, and arrow C indicates movement of elastic part 16.

In this exemplary embodiment, when retainer 15 comes into contact with stopper 17 of base 11, movement of hand H (arrow A) stops. FIG. 14 includes part (b) that is a graph showing movement of the whole of hand H (arrow A), movement of movable unit 10 (arrow B), and movement of elastic part 16 (arrow C) in a case of part (a) of FIG. 14. The graph of part (b) of FIG. 14 has a horizontal axis representing an elapsed time, and a vertical axis representing a distance (length of each arrow) from a start point to an end point of each of arrows A, B, and C.

The graph during a period of time [1] in part (b) of FIG. 14 is identical in state to that in the graph during the period of time [1] in part (b) of FIG. 13. When movable unit 10 is driven in a direction of arrow B to increase arrow B in length, retainer 15 in conjunction with the whole of hand H moves in a direction of arrow A to shorten arrow A in length. Elastic part 16 is not stretched during this period of time, so that arrow C is still constant in length.

Unlike time point [2] in part (b) of FIG. 13, retainer 15 comes into contact with stopper 17 at time point [2] in part (b) of FIG. 14. When retainer 15 comes into contact with stopper 17, movement of retainer 15 in conjunction with movement of the whole of hand H stops there. That is, arrow A is constant in length thereafter. In contrast, movable unit 10 is driven in the direction of arrow B to increase arrow B in length. Then, elastic part 16 begins to be stretched to increase arrow C in length. As also shown in the graph of part (b) of FIG. 14, gripping force for workpiece W, generated by gripper G, also increases.

Even during a period of time [3] in part (b) of FIG. 14, the movement of retainer 15 in conjunction with movement of the whole of hand H still stops due to stopper 17, and thus arrow A is constant in length. In contrast, movable unit 10 is driven in the direction of arrow B to further increase arrow B in length. Then, elastic part 16 is stretched to increase arrow C in length. As also shown in the graph of part (b) of FIG. 14, gripping force for workpiece W, generated by gripper G, also increases.

In a contact state with stopper 17, the leading end of hand H, for example, or workpiece W is assumed to be deformed. During the period of time [1] in part (b) of FIG. 14, even after gripper G comes into contact with workpiece W, arrow A may further shorten in length due to the deformation of hand H or workpiece W. In this case, retainer 15 moves to the “contact state with the stopper” to shorten arrow A in length, and then arrow A has a length at time point [2] in part (b) of FIG. 14.

As in the two exemplary embodiments illustrated in FIGS. 12 to 14, when retainer 15 comes into contact with workpiece W or stopper 17, movement of retainer 15 stops. Retainer 15 is interlocked with the whole of hand H, so that the stop of the movement of retainer 15 stops movement of the whole of hand H. However, when workpiece W to be gripped is soft, the leading end of hand H may change in attitude without change in position of retainer 15 in accordance with change in gripping force for workpiece W, generated by gripper G.

Movable unit 10 (arrow B) can move regardless of shape of stopper 17 and workpiece W, and thus always continues to move by a predetermined amount. Elastic part 16 (arrow C) moves in conjunction with movable unit 10 while retainer 15 moves, so that arrow C does not change in length. In contrast, after retainer 15 comes into contact with workpiece W or stopper 17 and stops, arrow C increases in length in accordance with movement of movable unit 10. In the illustrated example, a spring being elastic part 16 is stretched.

As described above, when hand H comes into contact with workpiece W, the elastic body (spring 20) changes in elastic force while at least a part of hand H stops changing in shape. This enables a gripping force of gripper G to be adjusted by the elastic body after hand H comes into contact with workpiece W.

The robot hand further includes stopper 17, and when the amount of movement of movable unit 10 reaches a predetermined value, stopper 17 stops changing in shape of at least a part of hand H. This enables a gripping force of gripper G to be adjusted while suppressing changing in shape of hand H when the amount of movement of movable unit 10 is more than or equal to the predetermined value.

The robot hand further includes an actuator, and the elastic body is spring 20. Spring 20 joins first joint shaft J1 of hand H to movable unit 10, and the actuator moves movable unit 10. This enables an elastic force of the elastic body to be adjusted by moving movable unit 10 under control of control system 100.

The robot hand may include only one actuator. This enables reducing the number of actuators while adjusting a gripping force. As a result, cost can be reduced, labor of wiring can be reduced to facilitate maintenance, and weight can be reduced.

Movable unit 10 is connected to an end, opposite to the leading end, of hand H, and the actuator is disposed at the end, opposite to the leading end, of hand H. This enables changing in shape of hand H and a gripping force of gripper G to be smoothly controlled by moving movable unit 10 in a direction away from the leading end of hand H with the actuator.

First joint shaft J1 includes no actuator. This enables reducing weight of a leading end portion of the robot hand, and reduces the labor of wiring.

Although the robot hands according to various exemplary embodiments of the present disclosure have been described above with reference to the drawings, it is needless to say that the present disclosure is not limited to such examples. It is apparent that those skilled in the art can conceive various modification examples, revision examples, substitution examples, addition examples, removal examples, equivalent examples, and the like within the scope of claims, and those examples are of course understood to be within the technical scope of the present disclosure. Additionally, each component in the various exemplary embodiments described above may be appropriately combined without departing from the spirit of the disclosure.

The present disclosure is useful as a robot hand capable of gripping a work.

What is claimed is:

1. A robot hand comprising:
a movable unit;
a hand that changes in shape in accordance with movement of the movable unit; and
an elastic body that changes a gripping force of the hand,
wherein when an amount of movement of the movable unit is less than a predetermined value, at least the hand changes in shape, and
when the amount of movement of the movable unit is more than or equal to the predetermined value, the elastic body changes in elastic force while at least a part of the hand stops changing in shape.

2. The robot hand according to claim 1, wherein
when the hand is in contact with a workpiece, the elastic body changes in elastic force while at least a part of the hand stops changing in shape.

3. The robot hand according to claim 1, further comprising a stopper,
wherein when the amount of movement of the movable unit reaches the predetermined value, the stopper stops the changing in shape of the at least a part of the hand.

4. The robot hand according to claim 1, further comprising an actuator,
wherein the elastic body is a spring,
the spring joins a first joint shaft of the hand to the movable unit, and
the actuator moves the movable unit.

5. The robot hand according to claim 4, wherein
the actuator comprises only one actuator.

6. The robot hand according to claim 4, wherein
the movable unit is connected to an end, opposite to a leading end, of the hand, and
the actuator is disposed at the end, opposite to the leading end, of the hand.

7. The robot hand according to claim 4, wherein
the first joint shaft includes no actuator.
